(19) United States
(12) Patent Application Publication
(10) Pub. No.: US 2011/0235706 A1
(43) Pub. Date: Sep. 29, 2011

(54) REGION OF INTEREST (ROI) VIDEO ENCODING

(75) Inventors: Mehmet Umut Demircin, Ankara (TR); Do-Kyoung Kwon, Allen, TX (US); Naveen Srinivasamurthy, Bangalore (IN); Manoj Koul, Bangalore (IN); Soyeb Nagori, Bangalore (IN)

(73) Assignee: TEXAS INSTRUMENTS INCORPORATED, Dallas, TX (US)

(21) Appl. No.: 13/053,419

(22) Filed: Mar. 22, 2011

Related U.S. Application Data
(60) Provisional application No. 61/317,562, filed on Mar. 25, 2010.

(51) Int. Cl. H04N 7/26

(52) U.S. Cl. 375/240.03; 375/E07.126

(57) ABSTRACT

A method of encoding an image frame in a video encoding system. The image frame has a region of interest (ROI) and a non region of interest (non-ROI). In the method, quantization scale for the image frame based on rate control information is determined. ROI statistics based on residual energy of the ROI and non-ROI is then calculated. Quantization scale for the image frame based on ROI priorities and ROI statistics is calculated. Further, quantization scales for ROI and non-ROI based on ROI priorities are determined.

This application claims priority from U.S. Provisional Application Ser. No. 61/317,562 filed Mar. 25, 2010, entitled “METHOD AND APPARATUS FOR OPTIMIZING RATE-DISTORTION AND ENHANCING QUALITY OF REGION OF INTEREST”, which is incorporated herein by reference in its entirety.

### TECHNICAL FIELD

Embodiments of the present disclosure relate generally to video encoding, and more specifically to transmission bit-rate control in a video encoder.

### BACKGROUND

Recently there has been an explosion of video based applications. Most of these applications require transmission of compressed video. The convergence of the Internet and mobile networks, introduces high demands on the video compression algorithms. On the one hand, emerging applications are targeting higher and higher video resolutions with Quad-HD video being the latest target. On the other hand, bandwidth is highly constrained on mobile networks. Hence, there is a strong need for achieving high compression ratio in order to enable transmission of Quad-HD video on low bandwidth mobile networks. In order to address this demand, understanding the application needs while compressing the video signal becomes of vital importance.

Region of Interest (ROI) coding is an emerging method to take into account the application and/or user needs and video characteristics while encoding video signals. It is well known that in video signals certain spatial and temporal regions or objects (in the video) of the video signal are of more interest/importance to the user than other areas.

Example applications and regions of interest/importance are (i) in video conferencing applications, the viewer pays more attention to the face regions when compared to other regions, (ii) in security applications, areas of potential activity (e.g. doors, windows) are more important. These more important regions or the regions where the viewer pays more attention to are called regions of interest (ROI). In such scenarios it is important that the ROI areas are reproduced as reliable as possible since they contribute significantly towards the overall quality and the end user perception of the video.

In ROI coding, the video encoder prioritizes the ROI areas and encodes them at higher fidelity when compared to non-ROI areas. This is achieved by assigning higher number of bits to the ROI areas when compared to non-ROI areas.

There are several challenges that need to be addressed in designing practical ROI based video compression systems. They are determination of ROI areas, bits allocation to ROI areas from the bit-budget, handling temporal ROI discontinuities, low delay algorithm to meet real-time constraints, a flexible algorithm to enable tuning to different application needs, and handling of multiple regions of interest, each potentially, with different priority.

### SUMMARY

This Summary is provided to comply with 37 C.F.R. §1.73, requiring a summary of the invention briefly indicating the nature and substance of the invention. It is submitted with the understanding that it will not be used to interpret or limit the scope or meaning of the claims.

An exemplary embodiment provides a method for encoding an image frame in a video encoding system. The image frame has a region of interest (ROI) and a non region of interest (non-ROI). In the method, quantization scale for the image frame based on rate control information is determined. ROI statistics based on residual energy of the ROI and non-ROI is then calculated. Quantization scale for the image frame based on ROI priorities and ROI statistics is calculated. Further, quantization scales for ROI and non-ROI based on ROI priorities are determined.

Another exemplary embodiment provides a method for encoding an image frame in a video encoding system. Average motion within the ROI for a current image frame is determined. An ROI for a next image frame by moving the ROI in the current image frame in the direction of motion by a value corresponding to the average motion is also determined. Then, the ROI for the next image frame in a subsequent image frame is used in response to a temporal discontinuity between the next image frame and the subsequent image frame.

An exemplary embodiment provides a video encoding system. The video encoding system includes a set of prediction blocks that calculates ROI statistics based on residual energy of the ROI and non-ROI; and a rate controller that receives encoded bits of an image frame, average quantization scale of the image frame, ROI priorities and ROI statistics and that generates quantization scale for the image frame by modulating quantization scale for the image frame.

Other aspects and example embodiments are provided in the Drawings and the Detailed Description that follows.

### BRIEF DESCRIPTION OF THE VIEWS OF DRAWINGS

FIG. 1 is a block diagram illustrating an environment, in accordance with which various embodiments can be implemented;

FIG. 2 is a block diagram of a video encoder system in accordance with an embodiment;

FIG. 3a is a flowchart illustrating a method for encoding a video signal, in accordance with an embodiment;

FIG. 3b illustrates a frame with a quantization guard band in accordance with an embodiment;

FIG. 4a is a flowchart illustrating a method for encoding a video signal, in accordance with another embodiment;

FIG. 4b illustrates temporal discontinuities in image frames; and

FIG. 5 is a block diagram illustrating the details of a digital processing system having a video encoder where several embodiments can be implemented.

### DETAILED DESCRIPTION OF THE EMBODIMENTS

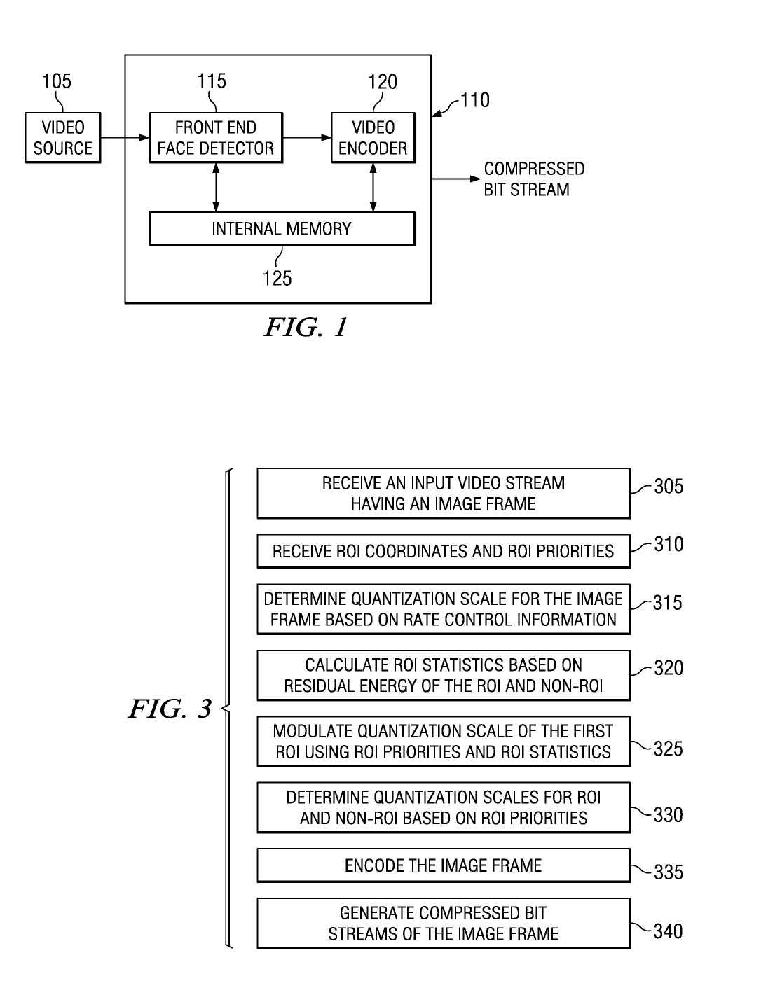

FIG. 1 is a block diagram illustrating an environment, in accordance with which various embodiments can be implemented. The environment includes a video source 105. The video source 105 generates a video sequence having a set of image frames. The image frames have a ROI and non-ROI defined. ROI refers to certain spatial and temporal regions or objects (in the image frame) of the video signal that are of more interest/importance to the user than other areas (non-ROI).

The video sequence is fed to a video system 110 for further processing. In an embodiment, the video source 105 is typically the CCD/CMOS sensor at the front-end of a camera. Examples of the video source 105 also include, but are not limited to, a playback from a digital camera, a camcorder, a mobile phone, a video player, and a storage device that stores recorded videos. The video source 105 is coupled to a front-end face detector 115 of the video system 110. In one embodiment, the front-end face detector 115 can be external to the video system 110. The front-end face detector 115 detects faces in the image frames. The front end face detector 115 is coupled to a video encoder 120 within the video system 110. The video encoder 120 receives the processed video sequence and the corresponding information from the front end face detector 115 and encodes the processed video sequence. The video encoder 120 encodes the input video sequence using one of standard video encoding algorithms such as H.263, H.264, and various algorithms developed by MPEG-4. The video system 110 further includes an internal memory 125 coupled to the front end face detector 115 and the video encoder 120.

Region of Interest (ROI) coding is an emerging method to take into account the application and/or user needs and video characteristics while encoding video signals. In ROI coding, the video encoder prioritizes the ROI areas and encodes them at higher fidelity when compared to non-ROI areas. This is achieved by assigning higher number of bits to the ROI areas when compared to non-ROI areas.

An embodiment proposes a rate-distortion (RD) optimized method for allocating bits to the ROI and non-ROI areas. The method, in an embodiment, is capable of handling temporal ROI discontinuities which may be caused due to limitations in the front-end ROI processor (e.g., face detection pre-processor). The proposed method has very low complexity and delay making it suitable for real-time implementation on low power/low cost/low memory embedded devices. The design is flexible to enable tuning to different application needs and also it is capable of handling multiple regions of interest.

It is well known that for ROI based encoders to achieve excellent end-user perceived quality, the number of bits used for the ROI areas may be increased when compared to non-ROI based encoding. However, the bit-allocation of the available bit budget between the ROI and non-ROI areas is not straight-forward. This bit-allocation plays a crucial role in the achieved subjective quality.

An available solution to solve this problem is an adhoc quantization scale (Qs) boost given to the macro-blocks (MBs) belonging to the ROI area. This has the limitation that it is not RD optimal since it does not take into account the statistics of the ROI and non-ROI areas. Furthermore, it does not try to maintain the bit-budget allocated to the frame. In another solution, the bit-allocation is addressed by using macro block standard deviation and number of non-zero DCT coefficients (ρ). This has the limitations that (i) it requires preprocessing of the entire frame to derive the standard deviation and ρ for every macro block of the frame. Such preprocessing is prohibitive in real time embedded video encoders, and, (ii) the proposed optimized allocation requires square root calculations while processing every macro block. This imposes high complexity demands making it unsuitable for embedded video encoders.

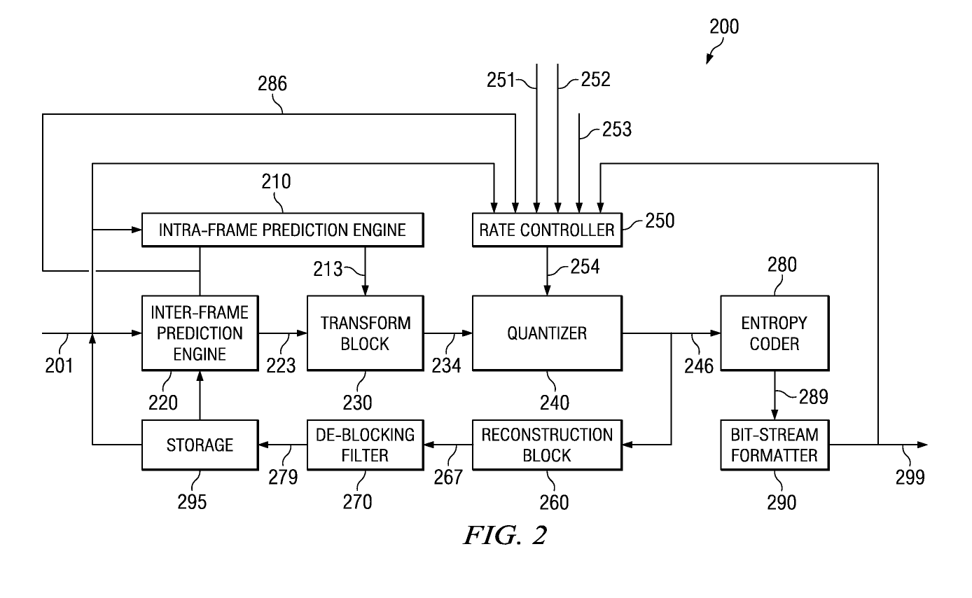

The rate-distortion (RD) optimized method is implemented in a video system as illustrated in FIG. 2.

FIG. 2 is a block diagram illustrating the details of an example device in which several embodiments can be implemented. Video encoding system 200 is shown containing intra-frame prediction engine 210, inter-frame prediction engine 220, transform block 230, quantizer 240, rate controller 250, reconstruction block 260, de-blocking filter 270, entropy coder 280, bit-stream formatter 290 and storage 295. The details of video encoding system 200 of FIG. 2 are meant merely to be illustrative, and real-world implementation may contain more blocks/components and/or different arrangement of the blocks/components. Video encoding system 200 receives image frames-(representing video) to be encoded on path 201, and generates a corresponding encoded frame (in the form of an encoded bit-stream) on path 299.

One or more of the blocks of video encoding system 200 may be designed to perform video encoding consistent with one or more specifications/standards, such as H.261, H.263, H.264/AVC, in addition to being designed to decide quantization scales for ROI and non-ROI regions during video encoding in a video encoding system as described in detail in sections below. The relevant portions of the H.264/AVC standard noted above are available from the International Telecommunications Union as ITU-T Recommendation H.264, “ITU-T Rec. H.264 and ISO/IEC 14496-10 (MPEG4-AVC), “Advanced Video Coding for Generic Audiovisual Services,” March 2010.”

In video encoding, an image frame is typically divided into several blocks termed macro-blocks, and each of the macro-blocks is then encoded using spatial and/or temporal compression techniques. The compressed representation of a macro-block may be obtained based on similarity of the macro-block with other macro-blocks in the same image frame (the technique being termed intra-frame prediction), or based on similarity with macro-blocks in other (reference) frames (the technique being termed inter-frame prediction). Inter-frame prediction of macro-blocks in an image frame may be performed using a single reference frame that occurs earlier than the image frame in display (or frame generation) order, or using multiple reference frames occurring earlier or later in the display order.

Referring to FIG. 2, image frames are received on path 201 may be processed by either intra-frame prediction engine 210 or inter-frame prediction engine 220 or both, depending on whether an intra-coded frame or inter-predicted frame is to be provided to transform block 230. The prediction engines (210 and 220) calculate ROI statistics based on residual energy of the ROI and non-ROI. The frames received on path 201 may be retrieved from a storage device (for example, storage 295 or other storage device(s) connected to path 201, but not shown), and may be in (YCbCr) format. Alternatively, the frames may be provided in (RGB) format, and converted (YCbCr) format internally in the corresponding blocks (blocks 210 and/or 220) prior to further processing.

Intra-frame prediction engine 210 receives frames on path 201. Intra-frame prediction engine 210 operates to encode macro-blocks of a received frames based on other macro-blocks in the same frame. Intra-frame prediction engine 210 thus uses spatial compression techniques to encode received frames. The specific operations to encode the frames may be performed consistent with the standard(s) noted above. Intra-frame prediction engine 210 may operate to determine correlation between macro-blocks in the frame. A macro-block determined to have high correlation (identical or near-identical content) with another (reference) macro-block may be represented by identifiers of the reference macro-block, the location of the macro-block in the frame with respect to the reference macro-block, and the differences (termed residual) between pixel values of the two macro-blocks. Intra-frame prediction engine 210 forwards the compressed representation of a macro-block thus formed, on path 213. For macro-blocks that are determined not to have high correlation with any other macro-block in the received frame, intra-frame prediction engine 210 forwards the entire (uncompressed) macro-block contents (for example, original Y, Cb, Cr pixel values of pixels of the macro-block) on path 213. The intra prediction cost (ROI statistics) of the macro block is given as an input to the rate controller 250 on line 286.

Inter-frame prediction engine 220 receives image frames on path 201, and operates to encode the frames to inter predicted frames. Inter-frame prediction engine 220 encodes macro-blocks of a frame to be encoded as a P-type frame based on comparison with macro-blocks in a ‘reference’ frame that occurs earlier than the frame in display order. Inter-frame prediction engine 220 encodes macro-blocks of a frame to be encoded as a B-type frames based on comparison with macro-blocks in a ‘reference’ frame that occurs earlier, later or both, compared to the frame in display order. The reference frame refers to a frame which is reconstructed after passing the output of the quantizer 240 through the reconstruction block 260 and de-blocking 270 before storing in storage 295. The inter prediction cost (ROI statistics) of the macro block is given as an input to the rate controller 250 on line 286.

Reconstruction block 260 receives compressed and quantized frames on path 246, and operates to reconstruct the frames to generate reconstructed frames. The operations performed by reconstruction block 260 may be the reverse of the operations performed by the combination of blocks 210, 220, 230 and 240, and may be designed to be identical to those performed in a video decoder that operates to decode the encoded frames transmitted on path 299. Reconstruction block 260 forwards reconstructed I-type frames, P-type frames and B-type frames on path 267 to de-blocking filter 270.

De-blocking filter 270 operates to remove visual artifacts that may be present in the reconstructed macro-blocks received on path 267. The artifacts may be introduced in the encoding process due, for example, to the use of different modes of encoding. Artifacts may be present, for example, at the boundaries/edges of the received macro-blocks, and de-blocking filter 270 operates to smoothen the edges of the macro-blocks to improve visual quality.

Transform block 230 transforms the residuals received on paths 213 and 223 into a compressed representation, for example, by transforming the information content in the residuals to frequency domain. In an embodiment, the transformation corresponds to a discrete cosine transformation (DCT). Accordingly, transform block 230 generates (on path 234) coefficients representing the magnitudes of the frequency components of residuals received on paths 213 and 223. Transform block 230 also forwards, on path 234, motion vectors (received on paths 213 and 223) to quantizer 240.

Quantizer 240 divides the values of coefficients corresponding to a macro-block (residual) by a quantization scale (Qs). Quantization scale is an attribute of a quantization parameter and can be derived from it. In general, the operation of quantizer 240 is designed to represent the coefficients by using a desired number of quantization steps, the number of steps used (or correspondingly the value of Qs or the values in the scaling matrix) determining the number of bits used to represent the residuals. Quantizer 240 receives the specific value of Qs (or values in the scaling matrix) to be used for quantization from rate controller 250 on path 254. Quantizer 240 forwards the quantized coefficient values and motion vectors on path 246.

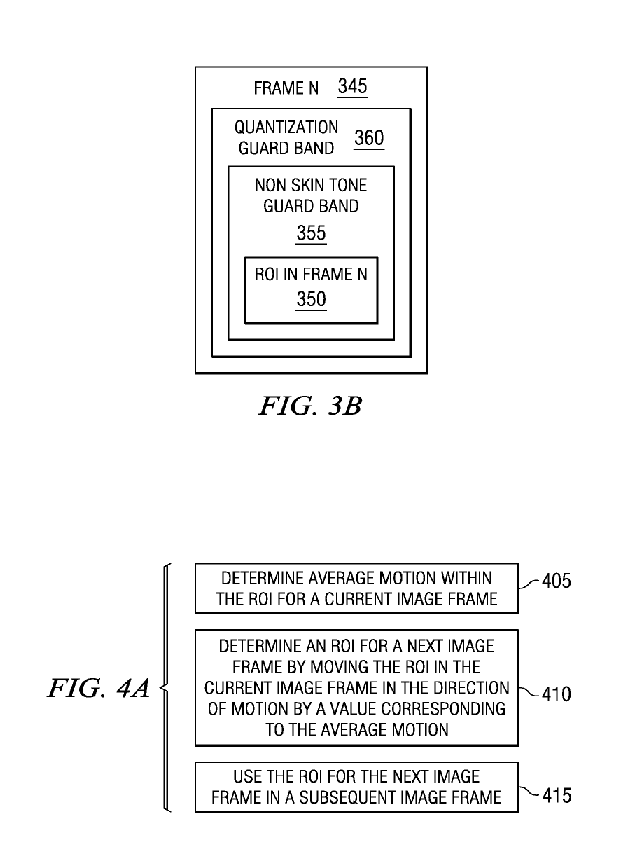

Rate controller 250 receives frames on path 201, and a ‘current’ transmission bit-rate from path 299, and operates to determine a quantization scale to be used for quantizing transformed macro-blocks of the frames (Qbase). The quantization scale is computed based on inputs received on paths 251 and 252. Encoded bits of the frames are received on path 251 and average quantization scale is received on path 252 and ROI priorities are received on path 253. As is well know, the quantization scale is inversely proportional to the number of bits used to quantize a frame, with a smaller quantization scale value resulting in a larger number of bits and a larger value resulting in a smaller number of bits. The rate controller uses ROI priorities and ROI statistics to generate the quantization scale for the current macro block. Details of generating the quantization scale is explained in FIG. 3 in detail. Rate controller 250 provides the computed quantization scale on path 254.

Entropy coder 280 receives the quantized coefficients as well as motion vectors on path 246, and allocates codewords to the quantized transform coefficients. Entropy coder 280 may allocate codewords based on the frequencies of occurrence of the quantized coefficients. Frequently occurring values of the coefficients are allocated codewords that require fewer bits for their representation, and vice versa. Entropy coder 280 forwards the entropy-coded coefficients as well as motion vectors on path 289.

Bit-stream formatter 290 receives the compressed, quantized and entropy-coded output 289 (referred to as a bit-stream, for convenience) of entropy coder 280, and may include additional information such as headers, information to enable a decoder to decode the encoded frame, etc., in the bit-stream. Bit-stream formatter 290 may transmit on path 299, or store locally, the formatted bit-stream representing encoded frames.

Assuming that video encoding system 200 is implemented substantially in software, the operations of the blocks of FIG. 2 may be performed by appropriate software instructions executed by one or more processors (not shown). In such an embodiment, storage 295 may represent a memory element contained within the processor. Again, such an embodiment, in addition to the processor, may also contain off-chip components such as external storage (for example, in the form of non-volatile memory), input/output interfaces, etc. In yet another embodiment, some of the blocks of FIG. 2 are implemented as hardware blocks, the others being implemented by execution of instructions by a processor.

It may be appreciated that the number of bits used for encoding (and transmitted on path 299) each of the frames received on path 201 may be determined, among other considerations, by the quantization scale value(s) used by quantizer 240.

FIG. 3a is a flowchart illustrating a method for encoding a video signal, in accordance with an embodiment. At step 305, an input video stream having an image frame is received. The image frame has a region of interest (ROI) and a non-region of interest (non-ROI). At step 310, ROI coordinates and ROI priorities are also received. The ROI coordinates includes whole numbers that represents the pixel position of the top left and bottom right of the ROI. ROI priorities include real numbers. If the ROI priority number for a ROI is higher, more bits are allocated to improve the quality of that ROI in the image frame while encoding the video and vice-versa.

At step 315, the base quantization scale for the image frame is determined by the rate control module using well known rate control algorithms (e.g. TM5, TMN5, etc).

Steps 320-330 are illustrated using the below example and equations. Assume that there are P ROI areas and α₁ α₂ α₃ . . . αₚ be the quality enhancements required for each ROI with α₁>α₂>α₃> . . . >α_{P}. For ease of analysis let the non-ROI area be the P+1^{th} ROI with α_{P+1}=1. The two design constraints for developing the ROI algorithm are on the rate and the distortion of the ROI and non-ROI areas.

The bits consumed by a frame after ROI encoding may be same or equivalent as the bits consumed by the frame when ROI encoding is not used, i.e.,

Rₙₒ_{_{—}}_{ROI}_{_{—}}_{coding}≈R_{ROI}_{₁}+R_{ROI}_{₂}+ . . . +R_{ROI}_{ₚ}+R_{ROI}_{ₚ₊₁} equation [1]

The distortion may be proportionally reduced based on the quality enhancement required for the ROI area. I.e., the ROI with highest quality enhancement may have the least distortion and the ROI with lowest quality enhancement may have the highest distortion.

Consider the case when there are only two areas (i) ROI area with quality enhancement α₁, and (ii) non-ROI area. Then, by setting the distortion in the ROI area to a factor of α₁ lesser than the distortion in the non-ROI area we can ensure that ROI area is represented with higher fidelity than the non-ROI area. I.e.,

D_{ROI}=Dₙₒₙ_{_{—}}_{ROI}/α₁ equation [2]

where, D is the distortion (mean square error).

Generalizing this to the case with multiple ROIs we get

$${D}_{{ROI}_{1}} = \frac{{D}_{{ROI}_{2}}}{\frac{{α}_{1}}{{α}_{2}}} = \frac{{D}_{{ROI}_{3}}}{\frac{{α}_{1}}{{α}_{3}}} … = \frac{{D}_{{ROI}_{p}}}{\frac{{α}_{1}}{{α}_{p}}} = \frac{{D}_{{ROI}_{p + 1}}}{\frac{{α}_{1}}{{α}_{p + 1}}} \qquad equation [ 3 ]$$

Here, we ensure the distortion is minimal for the ROI with highest quality enhancement. The distortion for the other ROIs increases as the quality factor associated with the ROI is reduced with the ROI area with the lowest quality enhancement gets the highest distortion.

It is well known that at high rates the distortion and quantization step size (i.e., H.264 quantization scale) are related by the following equation

$$D = \frac{{Q}^{2}}{12} \qquad equation [ 4 ]$$

where, D is the distortion (mean square error) and Q is the quantization scale.

Then, ROI statistics based on residual energy of the ROI and non-ROI is determined at step 320.

The relationship between rate and quantization scale can be modeled as proposed in [4].

$$R ∝ \frac{residual energy}{Q} + k \qquad equation [ 5 ]$$

where, R is the rate and k is a constant. Different measures can be used for residual energy measure. These include the sum of absolute difference (SAD), sum of square error (SSE), spatial activity or any other cost measurement metric. In this paper we make use of SAD as the residual energy measure as this is already available as an output from the motion estimation algorithm and thus necessitates no extra computational burden to compute the residual energy measure. Hence,

$$R ∝ \frac{SAD}{Q} + k \qquad equation [ 6 ]$$

From Eqs (3) and (4) we get the relation between the quantization scales for the different ROI areas,

$${Q}_{{ROI}_{1}} = {Q}_{{ROI}_{2}} / \sqrt{\frac{{α}_{1}}{{α}_{2}}} = {Q}_{{ROI}_{3}} / \sqrt{\frac{{α}_{1}}{{α}_{3}}} = … = {Q}_{{ROI}_{p + 1}} / \sqrt{\frac{{α}_{1}}{{α}_{p + 1}}} \qquad equation [ 7 ]$$

When ROI coding is not used, the quantization scale determined by rate control, Q_{base} is used. Hence,

$${R}_{no \_ ROI \_ coding} ∝ \frac{SAD}{{Q}_{base}} + k \qquad equation [ 8 ]$$

Similarly, the relation between the rate and quantization scale for ROI areas is:

$${R}_{{ROI}_{i}} ∝ \frac{{SAD}_{{ROI}_{i}}}{{Q}_{{ROI}_{i}}} + {k}_{i} , i = 1 … p + 1 \qquad equation [ 9 ]$$

Using Eq (7), (8) and (9) in (1) we get the RD optimized quantization scale for ROI area 1.

$${Q}_{{ROI}_{1}} = {Q}_{base} * ( \frac{\begin{matrix}{SAD}_{{ROI}_{1}} + \frac{{SAD}_{{ROI}_{2}}}{\sqrt{\frac{{α}_{1}}{{α}_{2}}}} + \frac{{SAD}_{{ROI}_{3}}}{\sqrt{\frac{{α}_{1}}{{α}_{3}}}} + … + \\ \frac{{SAD}_{{ROI}_{p + 1}}}{\sqrt{\frac{{α}_{1}}{{α}_{p + 1}}}}\end{matrix}}{\begin{matrix}{SAD}_{{ROI}_{1}} + {SAD}_{{ROI}_{2}} + {SAD}_{{ROI}_{3}} + … + \\ {SAD}_{{ROI}_{p + 1}}\end{matrix}} ) \qquad equation [ 10 ]$$

At step 325, the base quantization scale is modulated based on the ROI priorities and ROI statistics (see equation 10).

At step 330, the quantization scales for ROI and non ROI is determined based on ROI priorities (see equation 7). Further, the image frame is encoded at step 335 and compressed bit streams of the image are generated at step 340.

The above proposed ROI technique is also applicable for region of non interest (RONI) coding. By making a less than 1, the quantization scale assigned to RONI areas will be larger than that assigned to non-RONI areas. Thus, the quality of the RONI areas will be made worse than other parts of the video frame. This will enable masking of the regions which are not of interest.

A guard band is required around the ROI to include non-skin areas as part of the ROI. For e.g., a face detection algorithm returns the face region as the ROI. However, the surrounding areas around the face also need to be included (hair, neck, etc) also as part of the ROI. This guard band is proportional to the shape/size of the ROI. Geometric techniques are used to determine face of male, female or child and appropriately calculate the guard bands needed.

An abrupt change in quantization scale between ROI and non-ROI areas will result in sudden change in quality between adjacent macro blocks. This will result in subjective quality degradations. In order to overcome this problem an additional guard band (quantization guard band 360) is defined in the frame 360 around the ROI (ROI 350 and non skin tone guard band 355) calculated above as shown in FIG. 3b. The guard band is defined in the non ROI, where size of the guard band is proportional to the size of the ROI. Within the guard band the quantization scale is varied gradually from Q_{ROI} to Qₙₒₙ_{_{—}}_{ROI}.

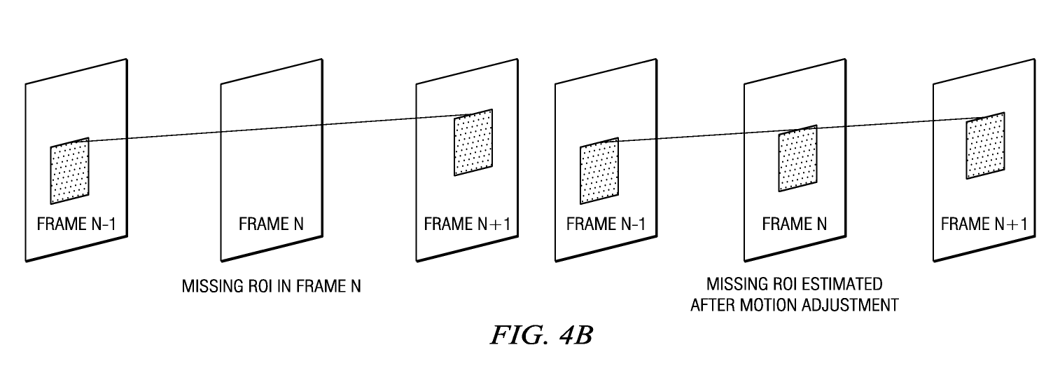

FIG. 4a is a flow diagram illustrating a method for solving temporal discontinuities of ROI in image frames. Consider the case of a face detector which identifies faces in the video frames. The face detectors will occasionally fail to detect a face even when it is present in the video frame. This is illustrated in FIG. 4b, the ROI is present in frame N−1 and frame N+1, but is missing in frame N. To, overcome this drawback, the information of ROI from past frames is used. Once a frame contains a ROI, this information is persisted for the next M frames. However, before using the ROI from current frame in the next frame, the ROI has to be moved to account for the velocity and direction of motion since the ROIs may be in motion from frame to frame. To solve this problem, at step 405, average motion with in the ROI for a current image frame is determined. The new ROI for next frame is determined by moving the ROIs in the current frame in the direction of motion by a value corresponding to the average motion at step 410. At step 415, the ROI for the next frame is used in a subsequent image frame(s). This is illustrated in 4b. The average motion of the ROI in preceding (P) frames is used to estimate the position of the ROI in Frame N by calculating the average velocity using the displacement of the ROI region. When multiple ROIs are present in a frame, the average motion within each of the ROIs is determined independently. The ROI areas are moved by the value of average motion and the estimated ROIs are used in the next frame. Steps 405-415 is performed only when it is detected that a ROI is missing from a frame else the ROI information provided by the face detect pre-processor is used.

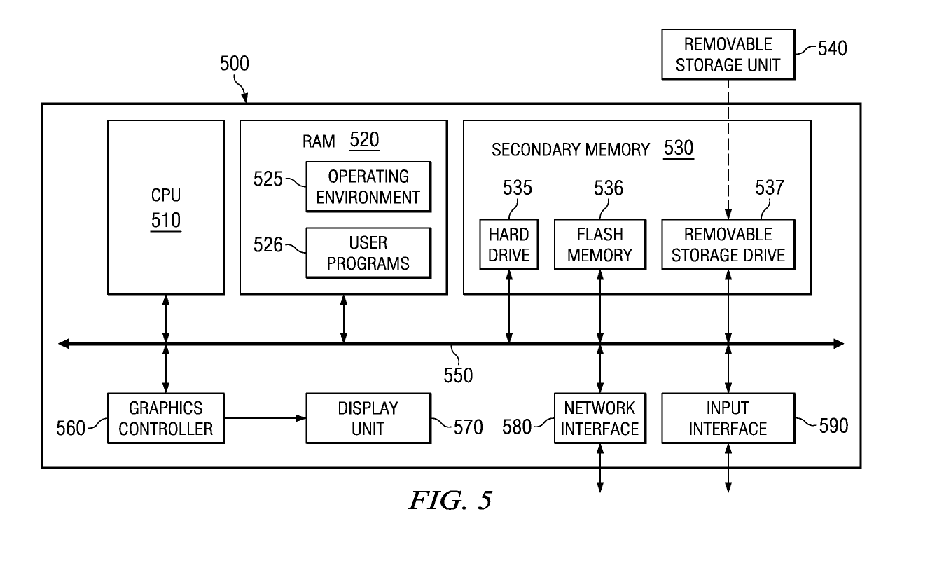

FIG. 5 is a block diagram illustrating the details of a digital processing system (500) in which several embodiments of video encoder 100 of FIG. 1 can be implemented and operative by execution of appropriate execution modules containing processor instructions. Digital processing system 500 may contain one or more processors such as a central processing unit (CPU) 510, random access memory (RAM) 520, secondary memory 530, graphics controller 560, display unit 570, network interface 580, and input interface 590. The components except display unit 570 may communicate with each other over communication path 550, which may contain several buses, as is well known in the relevant arts. The components of FIG. 5 are described below in further detail.

CPU 510 may execute instructions stored in RAM 520 to implement several of the embodiments described above. The instructions may include those executed by the various blocks of FIG. 1. CPU 510 may contain multiple processing units, with each processing unit potentially being designed for a specific task. Alternatively, CPU 510 may contain only a single general-purpose processing unit.

RAM 520 may receive instructions from secondary memory 530 via communication path 550. RAM 520 is shown currently containing software instructions constituting operating environment 525 and user programs 526 (such as are executed by the blocks of FIG. 1). The operating environment contains utilities shared by user programs, and such shared utilities include operating system, device drivers, etc., which provide a (common) run time environment for execution of user programs/applications.

Graphics controller 560 generates display signals (e.g., in RGB format) to display unit 570 based on data/instructions received from CPU 510. Display unit 570 contains a display screen to display the images defined by the display signals. Input interface 590 may correspond to a keyboard and a pointing device (e.g., touch-pad, mouse), and may be used to provide inputs. Network interface 580 provides connectivity (by appropriate physical, electrical, and other protocol interfaces) to a network (not shown, but which may be electrically connected to path 199 of FIG. 1), and may be used to communicate with other systems connected to the network.

Secondary memory 530 contains hard drive 535, flash memory 536, and removable storage drive 537. Secondary memory 530 may store data and software instructions, which enable digital processing system 500 to provide several features in accordance with the description provided above. The blocks/components of secondary memory 530 constitute computer (or machine) readable media, and are means for providing software to digital processing system 500. CPU 510 may retrieve the software instructions, and execute the instructions to provide several features of the embodiments described above.

Some or all of the data and instructions may be provided on removable storage unit 540, and the data and instructions may be read and provided by removable storage drive 537 to CPU 510. Floppy drive, magnetic tape drive, CD-ROM drive, DVD Drive, Flash memory, removable memory chip (PCMCIA Card, EPROM) are examples of such removable storage drive 537.

Removable storage unit 540 may be implemented using medium and storage format compatible with removable storage drive 537 such that removable storage drive 537 can read the data and instructions. Thus, removable storage unit 540 includes a computer readable (storage) medium having stored therein computer software and/or data. However, the computer (or machine, in general) readable medium can be in other forms (e.g., non-removable, random access, etc.).

Several embodiments of ROI coding algorithm as disclosed has the following advantages (i) it is developed in a RD optimized frame work—bit allocation to ROI areas is performed taking into account the statistics of the different regions, (ii) it has very low complexity making it ideal for implementation on embedded SOCs, (iii) it is capable of handling temporal discontinuities in ROI, which is very important for practical ROI video encoders, and, (iv) it can handle multiple regions of interest in a video frame, each potentially, with different quality enhancements.

The methods according to various embodiments are developed in a RD optimized framework. The bits allocated to the different ROI areas takes into account (i) the quality enhancement for the ROI area, and, (ii) the distortion in the ROI area. This ensures that bit distribution to the ROI areas is optimized taking into account both the perceptual importance of the ROI areas and the statistics of the ROI area.

The forgoing description sets forth numerous specific details to convey a thorough understanding of the invention. However, it will be apparent to one skilled in the art that the invention may be practiced without these specific details. Well-known features are sometimes not described in detail in order to avoid obscuring the invention. Other variations and embodiments are possible in light of above teachings, and it is thus intended that the scope of invention not be limited by this Detailed Description, but only by the following Claims.

What is claimed is:

1. A method for encoding an image frame in a video encoder, the method comprising:
determining quantization scale for the image frame based on rate control information, the image frame having a region of interest (ROI) and a non region of interest (non-ROI);
calculating ROI statistics based on residual energy of the ROI and non-ROI;
modulating quantization scale for the image frame based on ROI priorities and ROI statistics; and
determining quantization scales for ROI and non-ROI based on ROI priorities.

2. The method of claim 1, wherein prior to determining quantization scale for the image frame, comprising:
receiving an input video stream comprising the image frame;
receiving ROI coordinates; and
receiving ROI priorities.

3. The method of claim 1, wherein modulating quantization scale for the image frame comprises modulating based on available bit rate for the video encoder and distortion requirements for ROI and non-ROI.

4. The method of claim 1, wherein determining quantization scales for ROI and non-ROI further comprises calculating a relationship between quantization scales of ROI and non-ROI using bit rate approximation.

5. The method of claim 1, wherein calculating ROI statistics based on residual energy of the ROI and non-ROI further comprises:
calculating the residual energy using one of a sum of absolute difference, sum of square error, spatial activity and cost measurement metrics.

6. The method of claim 1 further comprising:
encoding the image frame; and
generating compressed bit streams of the image frame.

7. The method of claim 1, determining quantization scales for ROI and non-ROI based on ROI priorities and ROI statistics further comprises:
defining a guard band around the area of the ROI in the non ROI; and
determining quantization scale for the guard band, wherein size of the guard band is proportional to the size of the ROI.

8. A method for encoding an image frame having a region of interest (ROI) in a video encoder, the method comprising:
determining average motion within the ROI for a current image frame;
determining an ROI for a next image frame by moving the ROI in the current image frame in the direction of motion by a value corresponding to the average motion; and
using the ROI for the next image frame in a subsequent image frame in response to a temporal discontinuity between the next image frame and the subsequent image frame.

9. The method of claim 8 further comprising, prior to determining average motion within the ROI for a current frame, detecting the temporal discontinuity in the subsequent image frame.

10. The method of claim 8, wherein determining average motion within the ROI for a current image frame comprises determining average motion within a plurality of ROIs in the current image frame.

11. The method of claim 10, wherein determining average motion within a plurality of ROIs further comprises determining average motion within each of the plurality of ROIs independently.

12. The method of claim 11, wherein determining average motion comprises determining velocity and direction within the ROI.

13. A video encoding system comprising:
a set of prediction engines that calculate region of interest (ROI) statistics based on residual energy of a ROI and a non region of interest non-ROI in an image frame; and
a rate controller that receives encoded bits of an image frame, average quantization scale of the image frame, ROI priorities and the ROI statistics and that generates quantization scale for the image frame by modulating quantization scale for the image frame.

14. The video encoding system of claim 13, wherein the set of prediction engines comprise an inter-frame prediction engine and an intra-frame prediction engine.

15. The video encoding system of claim 13 further comprising a quantizer that receives the quantization scale to be used for quantization from rate controller.
